(19) United States
(12) Patent Application Publication
(10) Pub. No.: US 2025/0269888 A1
(43) Pub. Date: Aug. 28, 2025

(54) HAND TRUCK WITH LOAD ASSIST

(71) Applicant: Dorel Home Furnishings, Inc., Wright City, MI (US)

(72) Inventor: Kyle J. Lawrence, Greenfield, IN (US)

(21) Appl. No.: 19/065,897

(22) Filed: Feb. 27, 2025

Related U.S. Application Data
(60) Provisional application No. 63/559,139, filed on Feb. 28, 2024.
(60) Provisional application No. 63/704,441, filed on Oct. 7, 2024.
(60) Provisional application No. 63/715,253, filed on Nov. 1, 2024.

(51) Int. Cl. B62B 1/06

(52) U.S. Cl. CPC B62B 1/06

(57) ABSTRACT

A load transporter includes a wheel unit, a load support, and a hinge assembly comprising a left hinge unit, a right hinge unit, and a brace extending between and the left and right hinge units. The left hinge unit and the right hinge unit each include a wheel bracket coupled to the wheel unit and a support bracket coupled to the load support. Each wheel bracket is coupled to the respective support bracket for pivotable movement about a load-assist axis from an upright orientation, to a first-stage, laid back orientation, and for pivotable movement about a wheel axis defined by an axle of the wheel unit and spaced apart from the load-assist axis from the first-stage, laid-back orientation to a second-stage, laid-back orientation.

### PRIORITY CLAIM

This application claims priority to and the benefit of U.S. Provisional Application No. 63/559, 139 filed on Feb. 28, 2024; U.S. Provisional Application No. 63/704,441 filed on Oct. 7, 2024; and U.S. Provisional Application No. 63/715,253 filed on Nov. 1, 2024,the disclosure of which are expressly incorporated herein by reference in their entirety.

### BACKGROUND

The present disclosure relates to a load transporter and particularly to a load transporter with wheels and a toe plate. More particularly, the present disclosure relates to a load transporter that is adjusts to assist a user.

### SUMMARY

According to the present disclosure, a load transporter includes a wheel unit and a load support coupled to the wheel unit. The wheel unit is configured to allow the load transporter to roll across a surface while the load support holds an object above the surface. The load transporter may be tilted from an upright orientation to a laid-back orientation to lift the load support and any objects supported thereby above the surface for transportation along the surface.

In illustrative embodiments, the load transporter further includes a hinge assembly to transition the load transporter between an upright orientation; a first-stage, laid-back orientation; and a second-stage, laid back orientation. In the upright orientation, the load support is arranged generally parallel with a surface underlying the wheel unit and the load support so that the load support can be wedged beneath an object and the surface. The hinge assembly supports the load support for movement relative to the wheel unit about a load-assist axis from the upright orientation to the first-stage, laid-back orientation, where a front end of the load is lifted away from the surface while a rear end of the load support remains planted on the surface. In the second-stage, laid-back orientation, the hinge assembly supports the load support and the wheel unit for movement about an axle of the wheel unit to lift the load support off the surface so that the load transporter can roll across the surface and transport the object. The hinge assembly reinforces a connection between the load support and the wheel unit to block shifting of the load support relative to the wheel unit in all other directions except for pivotable movement about the load-assist axis.

In illustrative embodiments, the hinge assembly includes a left hinge unit, a right hinge unit, and a brace extending between and connecting the left and right hinge units. The left hinge unit and the right hinge unit each include a wheel bracket and a support bracket. The wheel bracket is fixed relative to the axle of the wheel unit and the support bracket is pivotably coupled to the wheel bracket about the load-assist axis. The brace extends between and connects the wheel bracket of each respective hinge unit to reinforce the hinge assembly and to unity the wheel brackets, the brace, the axle, and the wheels for motion as a unit during transition between the various orientations of the load transporter. This reinforcement and unification avoids instability of the load transporter potentially caused by unsynchronized movement of the left and right hinge units.

Each wheel bracket includes a wheel-bracket mount coupled to the wheel unit and a wheel-bracket guide that at least partially defines a channel. Each support bracket includes a support-bracket mount coupled to the load support and a support-bracket guide. Each support-bracket guide is disposed at least partially within the channel of a respective wheel-bracket guide. The wheel-bracket guide is coupled to the respective support-bracket guide for pivotable movement about the load-assist axis during transition between the upright orientation and the first-stage, laid-back orientation.

In illustrative embodiments, the wheel unit includes a first wheel, a second wheel, and an axle. The axle extends between and interconnects the first and second wheels. The axle is coupled to each of the wheel brackets of the hinge assembly. When transitioning between the first-stage, laid back orientation and the second-stage, laid-back orientation, the load support and hinge assembly pivot about the axle of the wheel unit.

In illustrative embodiments, the load support includes a support frame, a handle, and a toe plate. The handle is coupled to an upper end of the support frame. The toe plate is coupled to a lower end of the support frame, opposite the handle. The toe plate is coupled to each of the support brackets of the hinge assembly. When transitioning between the upright orientation and the first-stage, laid back orientation, the load support and support brackets pivot about the load-assist axis to lift or lower a front end of the toe plate relative to the surface underlying the wheel unit, while a rear end of the toe plate remains planted on the surface.

Additional features of the present disclosure will become apparent to those skilled in the art upon consideration of the following detailed description exemplifying the best mode of carrying out the disclosure as presently perceived.

### BRIEF DESCRIPTION OF THE DRAWINGS

FIG. 1 is a perspective view of a hand truck in accordance with the present disclosure, showing that the hand truck includes a load support, a wheel unit, and a pivotable hinge assembly in an upright orientation;

FIG. 2 is an enlarged section view taken along the section line of FIG. 1, showing a hinge unit of the hinge assembly in an upright orientation, and showing that the hinge unit includes a wheel-bracket, a support-bracket, and a spring to bias the wheel-bracket and support-bracket towards the upright orientation;

FIG. 3 is an enlarged section view taken along the section line of FIG. 1, but showing the hinge unit in a first-stage laid back orientation where the hand truck has been pivoted about a back corner of a toe plate of the hand truck, during which the spring has been compressed and the top of the support bracket has been pivoted towards the wheel-bracket about a load-assist axis;

FIG. 4 is an exploded perspective assembly view of a portion of the hand truck shown in FIG. 1, showing a detailed view of a portion of the hinge assembly, the load assembly, and the wheel unit, showing that the hinge assembly includes a brace connecting the hinge units, which each include a support bracket that attaches to the toe plate of the load support and a wheel bracket that couples to the axle of the wheel unit;

FIG. 5 is an enlarged perspective partial-assembly view of the wheel bracket and support bracket, showing that the wheel brackets each include a brace connecting and blocking torsion of the wheel brackets, a wheel-bracket guide coupled to the support bracket, and a wheel-bracket mount coupled to the wheel unit, and showing that the support brackets each include a support-bracket guide coupled to the wheel bracket and a support-bracket mount coupled to the load support;

FIG. 5A is an enlarged perspective view of the wheel brackets showing that the wheel-bracket mounts each include a plate, and showing that the wheel-bracket guides each include an inner plate, an outer plate, and a back plate that form a channel to receive the support-bracket guide and provide stability to the hinge units as the hand truck transitions between orientations;

FIG. 5B is an enlarged perspective view of the support brackets showing that the support-bracket mounts each include a pair of parallel plates and flanges to couple to the load support, and showing that the support-bracket guides each include a pair of parallel plates and a back plate that are received by and couple to the wheel-bracket guides to provide stability to the hinge units as the hand truck transitions between orientations;

FIG. 6 is an enlarged perspective view of the hinge assembly showing how the wheel brackets and support brackets are coupled and pivotable about the load-assist axis during transition of the hand truck from the upright orientation to the first-stage, laid back orientation;

FIG. 7A is an enlarged detail view of the hand truck shown in FIG. 1 in an upright orientation, showing the position of the support bracket, wheel bracket, and toe plate with respect to one another in the upright orientation, specifically how a first flat of the wheel bracket abuts against the toe plate in the upright orientation;

FIG. 7B is an enlarged section view of FIG. 7A, showing the position of the support bracket and wheel bracket with respect to one another in the upright orientation, and showing the spring biasing the support bracket and wheel bracket towards the upright orientation;

FIG. 8A is an enlarged detail view of the hand truck shown in FIG. 1 in the first-stage, laid back orientation where the hand truck has been pivoted about the back corner of the toe plate, showing the position of the support bracket, wheel bracket, and toe plate with respect to one another in the first-stage, laid back orientation, specifically how a second flat of the wheel bracket now abuts against the toe plate in the first-stage, laid back orientation;

FIG. 8B is an enlarged section view of FIG. 8A, showing the position of the support bracket and wheel bracket with respect to one another in the first-stage, laid back orientation, and showing how the top of the support bracket has been pivoted towards the wheel bracket about the load-assist axis and how the spring is now compressed against the wheel bracket;

FIG. 9A is an enlarged detail view of the hand truck shown in FIG. 1 in the second-stage, laid back orientation where the hand truck has been pivoted about the wheel axle, showing the position of the support bracket, wheel bracket, and toe plate with respect to one another in the second-stage, laid back orientation, specifically how the second flat of the wheel bracket still abuts against the toe plate in the second-stage, laid back orientation as the toe plate has been lifted off of the underlying surface;

FIG. 9B is an enlarged section view of FIG. 9A, showing the position of the support bracket and wheel bracket with respect to one another in the second-stage, laid back orientation, and showing how the top of the support bracket is still pivoted towards the wheel bracket about the load-assist axis and the spring remains compressed against the wheel bracket;

FIG. 10 is a perspective partial-assembly view of the had truck of FIG. 1 showing the load support, hinge assembly, and wheel unit sub-assemblies and all of their individual components;

FIG. 11 is a perspective view of another embodiment of a support frame of a load support for a hand truck, showing the support frame includes hooks allowing straps to be attached to the hand tuck for securing loads;

FIG. 12 is a perspective view of another embodiment of the hinge assembly, showing another embodiment of the spring to bias the support bracket and wheel bracket towards the upright orientation;

FIG. 13 is a perspective view of another embodiment of a hand truck in accordance with the present disclosure, showing the hand truck in an upright orientation and including a load support, a wheel unit, and a hinge assembly having left and right hinge units and a brace extending between the left and right hinge units to block independent movement of one hinge unit relative to the other as the hand truck moves between the upright orientation to a first stage, laid-back orientation, as shown in FIG. 3;

FIG. 14 is an enlarged section view taken along the section line of FIG. 13, showing portions of the hand truck in the upright orientation, and showing that each hinge unit includes a wheel bracket, a support bracket, and a spring configured to bias the wheel bracket relative to the support bracket about a load-assist axis to urge the hand truck towards the upright orientation;

FIG. 15 is an enlarged section view taken along the section line of FIG. 13, but showing portions of the hand truck in a first-stage laid back orientation following pivotal movement of the load support and the support bracket about the load-assist axis relative to the wheel unit and the wheel bracket;

FIG. 16 is an exploded perspective assembly view of a portion of the hand truck shown in FIG. 13, showing each support bracket formed to include a channel defined at least partially by opposed support plates configured to simply support each respective wheel bracket thereto to establish the load-assist axis about which the load support and the support bracket pivot as the hand truck moves from the upright orientation to the first-stage, laid-back orientation;

FIG. 17 is an enlarged perspective partial-assembly view of the left and right hinge units, showing the brace interconnecting the wheel brackets to block independent movement of the wheel brackets relative to one another as the hand truck moves between the upright orientation and the first-stage, laid-back orientation;

FIG. 18 is an enlarged perspective view of the hinge units attached to the load support showing that the support brackets each include a pair of opposed, parallel plates and flanges to couple each support bracket to the load support and showing the wheel brackets and support brackets coupled to one another and pivotable about the load-assist axis relative to one another during transition of the hand truck from the upright orientation to the first-stage, laid back orientation;

FIG. 19 is a cross section of a portion of the hand truck shown in FIG. 13 in the upright orientation, showing the position of the support bracket, wheel bracket, and toe plate with respect to one another in the upright orientation, specifically how a first surface of the wheel bracket abuts against the support bracket in the upright orientation;

FIG. 20 is cross section of a portion of the hand truck showing the hand truck in the first-stage, laid back orientation where the hand truck has been pivoted about the back corner of the toe plate, showing the position of the support bracket, wheel bracket, and toe plate with respect to one another in the first-stage, laid back orientation, specifically how a second surface of the wheel bracket abuts against the support bracket in the first-stage, laid back orientation;

FIG. 21 is cross section of the hand truck shown in FIG. 13 in a second-stage, laid back orientation where the hand truck has been pivoted about the wheel axle and the toe plate has been lifted off of the underlying surface while the second flat surface remains in contact with the support bracket;

FIG. 22 is a cross section the hand truck of FIG. 13 showing the load support including left and right support rails each formed to include a dovetailed channel configured to receive a portion of each respective support bracket; and

FIG. 23 is an enlarged portion of FIG. 22 showing one of the support rails and one of the support brackets including a support-bracket mount having a corresponding shape to the dovetailed channel and received in the channel to mount the support bracket to the load support.

### DETAILED DESCRIPTION

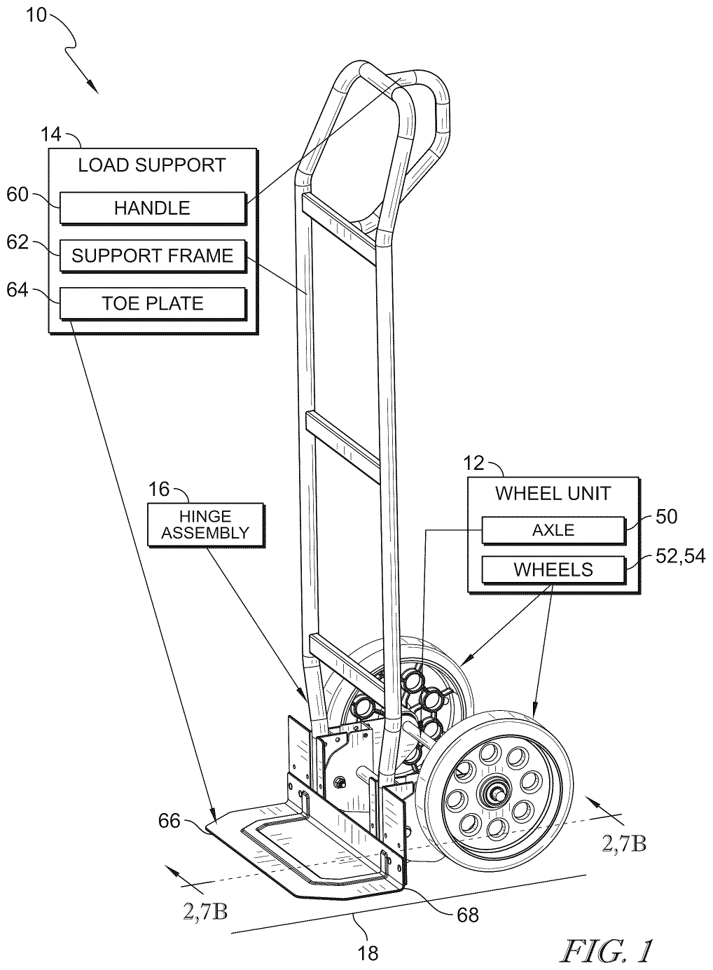

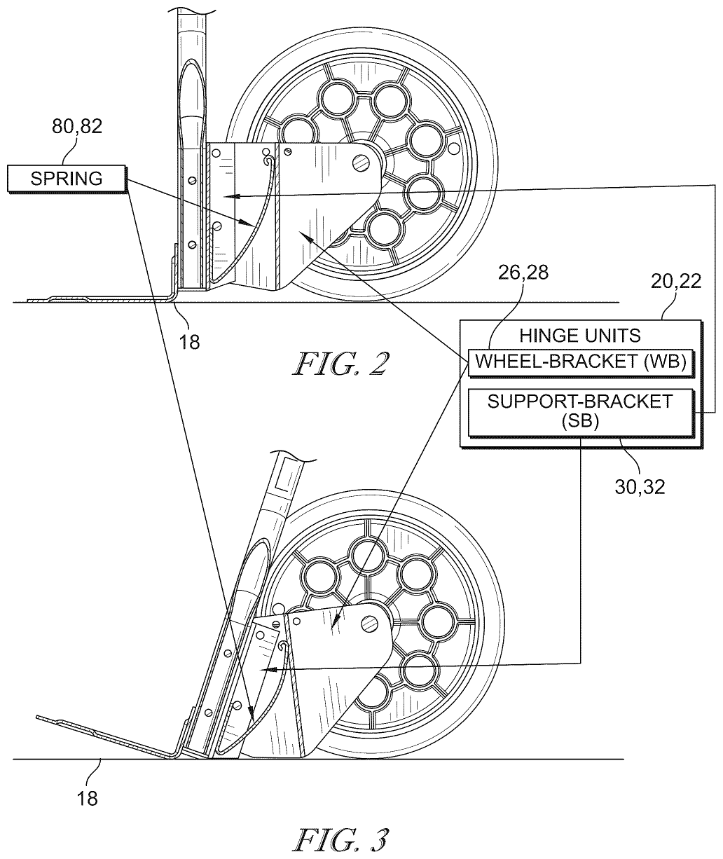

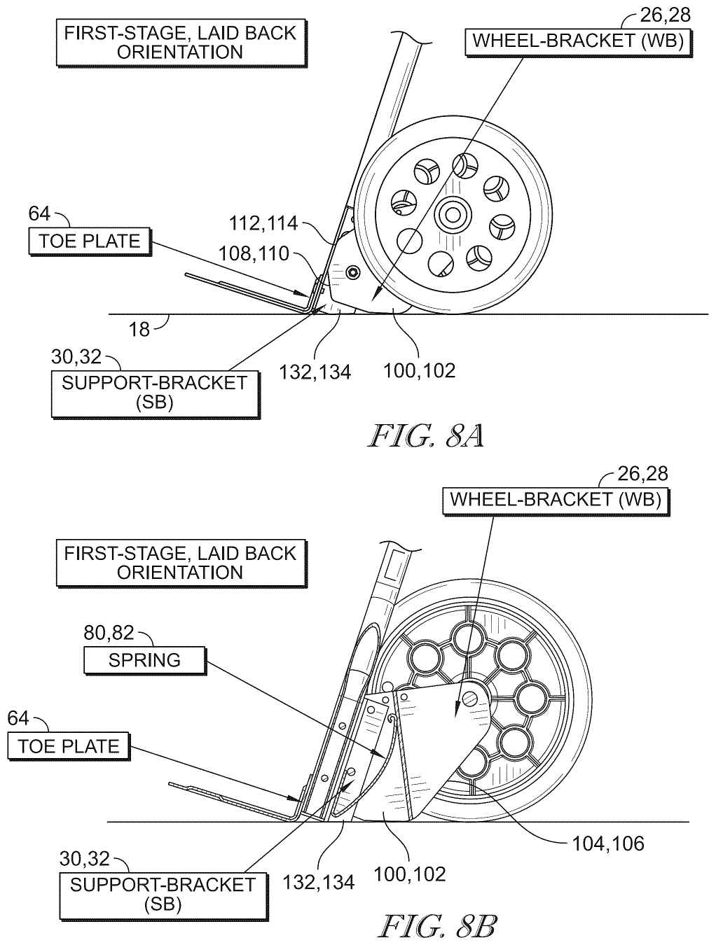

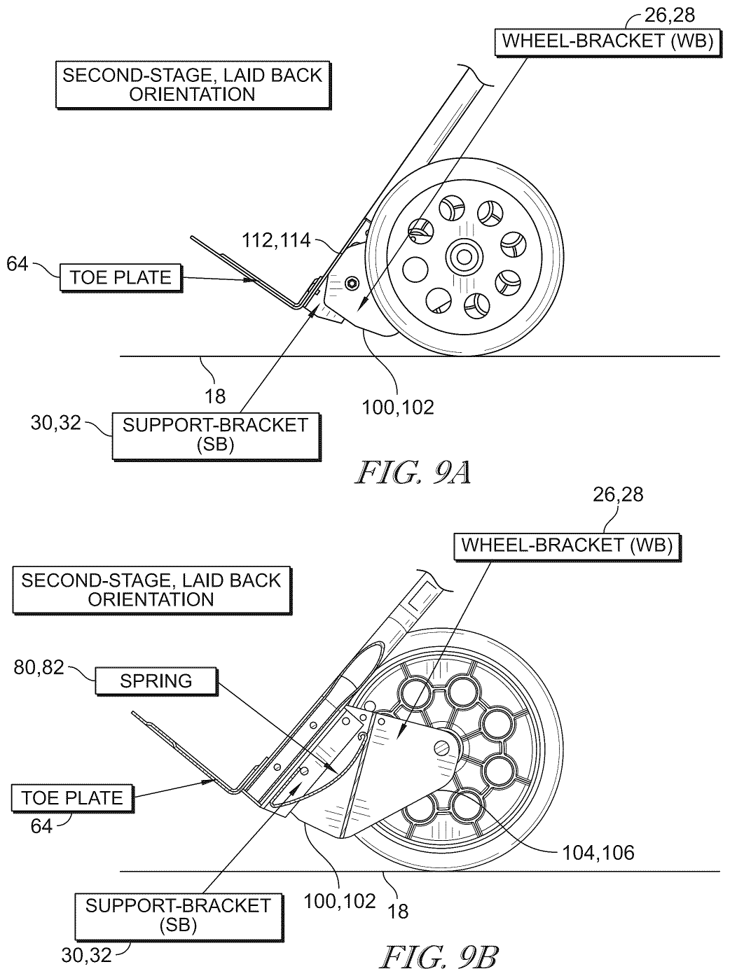

A load transporter 10 in accordance with the present disclosure is shown in FIG. 1 and includes a wheel unit 12 and a load support 14 rotatably coupled to the wheel unit 12. The load support 14 is configured to support a load and be manipulated by the user to transport the load. The wheel unit 12 allows the load support 14 to be rolled across a surface by the user to transport the load. The load support 14 is configured to pivot relative to the wheel unit 12 to change between an upright orientation as shown in FIGS. 1-2 and 7A-7B, to a first-stage, laid back orientation as shown in FIGS. 3 and 8A-8B, and to a second-stage, laid back orientation as shown in FIGS. 9A-9B to help an operator lift and transport objects across a surface 18.

The load transporter 10 further includes a hinge assembly 16 configured to couple the wheel unit 12 to the load support 14 to allow the load support 14 to pivot relative to the wheel unit 12 between the upright orientation as shown in FIGS. 1-2 and 7A-7B and the first-stage, laid back orientation as shown in FIGS. 3 and 8A-8B. The hinge assembly 16 includes a pair of hinge units 20, 22 and a brace 24 extending between and connecting the hinge units 20, 22. The hinge units 20, 22 are disposed on opposite ends of the brace 24 and couple the brace 24 to the wheel unit 12 and the load support 14.

The brace 24 couples the hinge units 20, 22 together at a location that is offset from the pivot axes, or the axes about which the load support 14 pivots relative to the wheel unit 12 during movement between the various orientations. The brace 24 provides additional support to the hinge assembly 16 by blocking the individual hinge units 20, 22 of the hinge assembly 16 from wobbling, shifting, or from moving independently or asynchronously from each other during movement of the load support 14 and load transporter 10. These features of the hinge assembly 16 increase stability and provide a more robust connection between the load support 14 and the wheel unit 12, particularly during transitions between the various orientations when the center of gravity of a load on the load transporter 10 is changing.

Each hinge unit 20, 22 includes a wheel bracket 26, 28 and a support bracket 30, 32 coupled to a respective wheel bracket 26, 28. The two-bracket design allows the load support 14 to pivot relative to the wheel unit 12 between the upright orientation as shown in FIGS. 1-2 and 7A-7B and the first-stage, laid back orientation as shown in FIGS. 3 and 8A-8B. Each wheel bracket 26, 28 couples the wheel unit 12 to the hinge assembly 16. Each support bracket 30, 32 couples the load support 14 to the hinge assembly 16.

Each wheel bracket 26, 28 of the hinge assembly 16 includes a respective wheel-bracket mount 34, 36 and a wheel-bracket guide 38, 40. Each of the wheel-bracket mounts 34, 36 couple to an axle 50 of the wheel unit 12. The axle 50 extends between the wheel-bracket mounts 34, 36 parallel to the brace 24 that connects the two hinge units 20, 22. Each of the wheel-bracket mounts 34, 36 forms a plate 84, 86 that extends substantially perpendicular to the axle 50 and parallel to the wheels 52, 54 of the wheel unit 12. The plate 84, 86 of each wheel-bracket mount 34, 36 is formed to include an aperture 74, 76 through which the axle 50 extends, coupling the hinge units 20, 22 to the wheel unit 12 so the wheel brackets 26, 28 can rotate about the axle 50. The axle 50 creates a pivot point for the hinge units 20, 22 to pivot about as the load support 14 transitions between the first-stage, laid back orientation (shown in FIGS. 8A-8B) and the second-stage, laid back orientation (shown in FIGS. 9A-9B).

A respective wheel-bracket guide 38, 40 is disposed at an opposite end of each wheel bracket 26, 28 from the wheel-bracket mount 34, 36. The brace 24 is connected to and extends between the wheel-bracket guides 38, 40. The brace 24 extends substantially perpendicular to the wheel-bracket mounts 34, 36. The brace 24, the wheel-bracket guides 38, 40, and the wheel-bracket mounts 34, 36 form a rigid, unitary structure, further blocking instability and wobbling of the individual hinge units 20, 22 with respect to one another.

The brace 24 is offset rearward from the load-assist axis 70 and forward of the axle 50. In other words, in the horizontal direction, the brace 24 is disposed between the load-assist axis 70 and the wheel unit 12. In the illustrative embodiment, a center point or central axis of the brace 24 is offset above the load-assist axis 70 and below the axle 50, such that the brace 24 is disposed between the axle 50 and the load-assist axis 70 in the vertical direction. The brace 24 is positioned closer to the load-assist axis 70 than the axle 50 in both the vertical and horizontal direction.

Each wheel-bracket guide 38, 40 includes an inner side plate 88, 90, an outer side plate 92, 94 extending parallel with the inner side plate 88, 90, and a back plate 96, 98 extending between each respective inner side plate 88, 90 and each respective outer side plate 92, 94. The inner side plate 88, 90, the outer side plate 92, 94, and the back plate 96, 98 of each wheel-bracket guide 38, 40 are shaped to form a respective U-shaped wheel-bracket channel 38a, 40a. The brace 24 is coupled to and extends between the two inner side plates 88, 90 of each of the wheel-bracket guides 38, 40. The outer side plates 92, 94 of the wheel-bracket channels 38a, 40a extend from and are co-linear with the plate 84, 86 of the respective wheel-bracket mount 34, 36, forming a unitary, rigid wheel bracket 26, 28. Each of the wheel-bracket channels 38a, 40a cooperate with and receive a respective support bracket 30, 32. A portion of the support bracket 30, 32 fits within and overlaps the side walls 88, 90, 92, 94 of a respective wheel-bracket channel 38a, 40a to support transitioning the load support 14 between the different orientations.

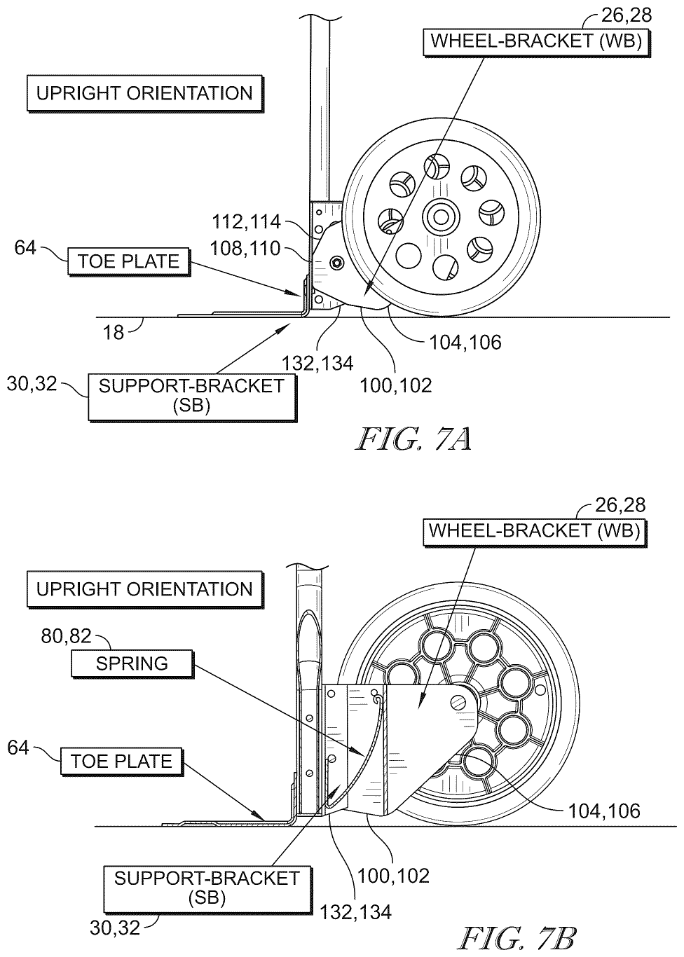

The inner and outer side plates 88, 90, 92, 94 of the wheel-bracket guides 38, 40, along with the plate 84, 86 of the wheel-bracket mount 34, 36, are angled on a bottom edge of the plates, as shown in FIGS. 7-9. The angled shape of the plates 84, 86, 88, 90, 92, 94 provide support and assist the transition between the different orientations. An angle of the bottom edge 100, 102 of the wheel-bracket guide 38, 40 slopes upwards as it extends from the wheel-bracket mount 34, 36 towards the load support 14. An angle of the bottom edge 104, 106 of the wheel-bracket mount 34, 36 slopes upwards as it extends from the wheel-bracket guide 38, 40 towards the axle 50 of the wheel unit 12.

In the upright orientation, the wheel brackets 26, 28 are both lifted off the underlying surface 18, as shown in FIG. 7A-7B. In the first-stage, laid back orientation, the bottom edge 100, 102 of the wheel-bracket guide 38, 40 rests on the underlying surface 18, shown in FIGS. 8A-8B. In the first-stage, laid back orientation, the bottom edge 100, 102 resting on the surface 18 at least partial helps support the weight of a load on the load support 14. The shape of the bottom edge 100, 102 also provides support and stability as the load is transitioned between the upright orientation and the first-stage, laid back orientation.

A forward portion of each of the inner 88, 90 and outer side plates 92, 94 of the wheel-bracket guides 38, 40 disposed near the support-bracket mount 42, 44 also include a respective first edge 108, 110, and a respective second edge 112, 114. The first edge 108, 110 and second edge 112, 114 are angled with respect to each other. The first edge 108, 110 extends in a substantially vertical direction when the load support 14 is in the upright orientation, shown in FIGS. 7A-7B, and the first-stage laid back orientation, shown in FIGS. 8A and 8B. The first, vertical edge 108, 110 abuts a portion of the support-bracket mount 42, 44 when the load support is in the upright orientation.

The second edge 112, 114 is angled with respect to the first edge 108, 110 and extends back and upwards from the first vertical edge 108, 110, towards an upper portion of the back plate of the wheel-bracket channel 38a, 40a. The intersection of the first 108, 110 and second edges 112, 114 act as a fulcrum or pivot point as the load support transitions between the upright orientation and the first-stage, laid back orientation. A portion of the support-bracket mounts 42, 44 rest against the second edge 112, 114 of the parallel channel plates 88, 90, 92, 94 in the first-stage, laid back orientation as shown in FIGS. 8A-8B and in the second-stage, laid back orientation as shown in FIGS. 9A-9B. By supporting the support brackets 30, 32 and the attached toe plate 64, the shape of the plates 88, 90, 92, 94 of the wheel-bracket channels 38a, 40a act as a cam or guide to further support and stabilize the movement of the load support 14 during transition between the various orientations.

Turning to the support brackets 30, 32 of the hinge assembly 16, each support bracket 30, 32 includes a support-bracket mount 42, 44 and a support-bracket guide 46, 48. At least a portion of the support-bracket mounts 42, 44 extends substantially perpendicular to at least a portion of the support-bracket guides 46, 48 and couples to the load support 14. Each support-bracket mount 42, 44 includes a pair of flanges 116, 118 and is formed to include a support-mount channel 42a, 44a formed by parallel plates 124, 126. The pair of flanges 116, 118 extend outward, away from the channel 42a, 44a. The flanges 116, 118 are attached to and sit flush against the toe plate 64 of the load support 14. The toe plate 64 extends between the two support-bracket mounts 42, 44 of the hinge assembly 16 and couples the support-bracket mounts 42, 44 to the load support 14. The toe plate 64 and the flanges 116, 118 of each support-bracket mount 42, 44 are each formed to include a plurality of apertures. When assembled, the apertures in the flanges 116, 118 align with the apertures in the toe plate 64, and fasteners extend through the aligned apertures and couple the support brackets 30, 32 to the toe plate 64.

The plates 124, 126 of each support-bracket mount 42, 44 at least partially surrounds a portion of a support frame 62 of the load support 14 disposed between the toe plate 64 and the channel 42a, 44a. The support frame 62 and plates 124, 126 forming the channel 42a, 44a of the support-bracket mounts 42, 44 form apertures that align when assembled. Fasteners extend through the aligned apertures of the frame 62 and support-bracket mounts 42, 44 to further fasten the support brackets 30, 32 to the load support 14. The channel 42a, 44a and flanges 116, 118 provide a robust and stable connection between the load support 14 and the support brackets 30, 32. In some embodiments, as shown in FIG. 11, the frame 164 of the load support 114 may comprise one or more hooks 166 disposed along the sides of the frame 164. The hooks 166 may allow straps to be tied or hooked to the frame 164 to secure loads transported by the hand truck 10.

At an opposite end of each of the support brackets 30, 32 from the support-bracket mount 42, 44 is a respective support-bracket guide 46, 48. Each of the support-bracket guides 46, 48 defines a respective support-guide channel 46a, 48a formed by a pair of parallel plates 128, 130. The plates 128, 126 extend perpendicular to the toe plate 64 and the flanges 116, 118 of the support-bracket mounts 42, 44, and extend from and are co-linear with the plates 124, 126 of the respective support-bracket mount 42, 44. The support-bracket guides 46, 48 include a plate 120, 122 that extends between the parallel plates 128, 130 and separates the support-mount channel 42a, 44a of the support-bracket mount 42, 44 and the support-guide channel 46a, 48a of the support-bracket guide 46, 48.

The support-bracket guides 46, 48 extend parallel to the wheel-bracket guides 38, 40 and wheel-bracket channels 38a, 40a. Each support-guide channel 46a, 48a cooperates with and is received by a respective wheel-bracket channel 38a, 40a. When assembled, the parallel plates 128, 130 of each of the support-bracket guides 46, 48 fit within the parallel plates 88, 90, 92, 94 of a respective wheel-bracket guide 38, 40.

When assembled, the parallel plates 128, 130 of the support-guide channels 46a, 48a are both disposed within a respective wheel-bracket channels 38a, 40a and extend towards the back plate 96, 98 of the wheel-bracket channels 38a, 40a. The walls of the wheel-bracket channels 38a, 40a, extend outside of and overlap the walls of the support-guide channels 46a, 48a, extending towards the support-bracket mount 42, 44. The shape and overlap of the respective plates 88, 90, 92, 94, 128, 130 reinforce the hinge units 20, 22 and provide stability to the hinge units 20, 22 as the load support 14 is transitioned between the different orientations.

The respective parallel plates 128, 130 of the support-guide channel 46a, 48a and the parallel plates 88, 90, 92, 94 of the wheel-bracket channel 38a, 40a form apertures that align when assembled to allow for a pin 72 to extend through each respective hinge unit 20, 22. A respective pin 72 extends through each hinge unit 20, 22 to couple the support-bracket guide 46, 48 to a respective wheel-bracket guide 38, 40. The pin 72 provides pivotable movement between the support brackets 30, 32 and the wheel brackets 26, 28 about a load-assist axis 70, with the pins 72 defining the load-assist axis 70. The pins 72 couple each support bracket 30, 32 to a respective wheel bracket 26, 28. The support brackets 30, 32 fix a position of the pin 72 and load-assist axis 70 relative to the load support 14. The wheel brackets 26, 28 fix a distance of the pin 72 and load-assist axis 70 from the wheel unit 12.

In some embodiments, the support-guide channel 46a, 48a and the wheel-bracket channel 38a, 40a of each hinge unit 20, 22 enclose a spring 80 configured to bias the load support 14 towards the upright orientation. The spring 80 may be a plate spring or flat spring, as shown in FIGS. 7-9. One end of the spring 80 abuts a lower portion of the plate 120, 122 of the support bracket 30, 32. An opposite end of the spring abuts an upper portion of the back plate of the wheel bracket 26, 28, and applies a force that biases the back plate 96, 98 and the plate 120, 122 to be parallel to each other.

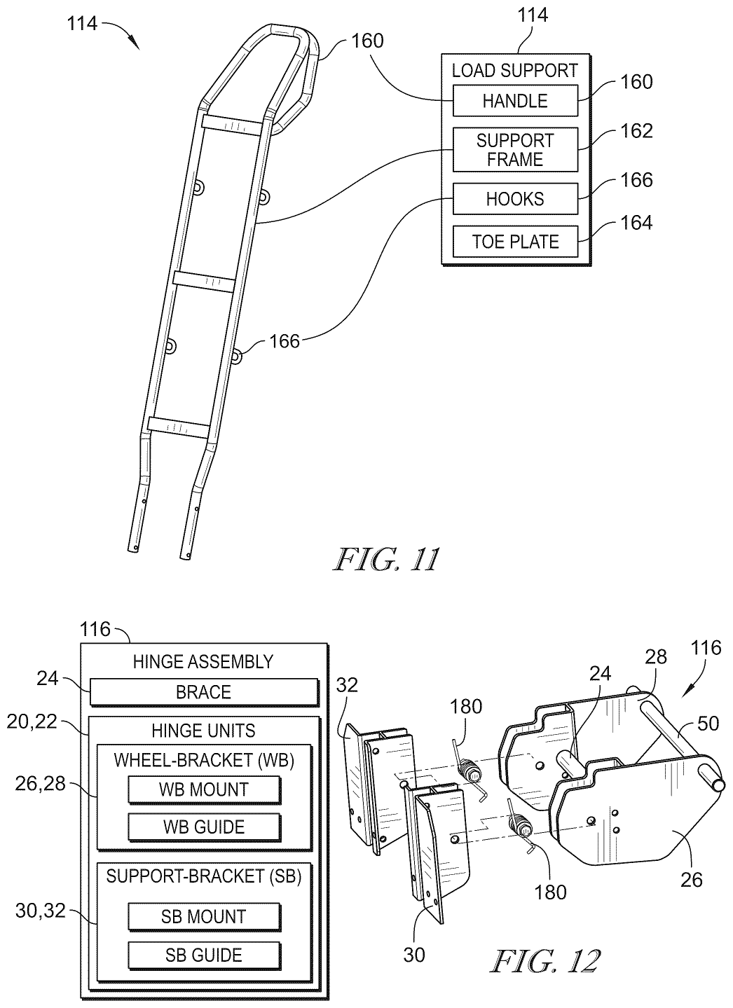

In some embodiments, the spring 80 may cooperate or engage with the pin 72 of each hinge unit 20, 22 to keep the spring 80 in place. The spring 80 may be attached or coupled to the support bracket 30, 32 via fasteners. In some embodiments, the spring 80 may be a torsion spring, or any other suitable spring mechanism capable of providing a force to bias the load support 14 and the hinge assembly 16 towards the upright orientation as shown in FIGS. 7A-7B. In some embodiments, as shown in FIG. 12, the spring 180 may be a coil or torsion spring disposed around the hinge point of the hinge assembly.

The parallel plates 128, 130 of the support-bracket guides 46, 48 are angled on the bottom edge 132, 134 of the plates, as shown in FIGS. 7-9. The angled shape of the plates assist the transition between the different orientations. The angle of the bottom edge of the support-bracket guides 46, 48 slopes upwards as it extends from the toe plate 64 towards the wheel bracket 26, 28. In the upright orientation, as shown in FIGS. 7A-7B, the support brackets 30, 32 are both lifted off the surface 18. In the first-stage, laid back orientation, the bottom edge 132, 134 of the support brackets 30, 32 rests on the surface 18, acting as a support surface as the load is transitioned between the upright orientation and the first-stage, laid back orientation.

The load support 14 is configured to pivot relative to the wheels 52, 54 about the load-assist axis 70 provided by the hinge assembly 16 to transition the load transporter 10 from an upright orientation, as shown in FIGS. 1-2 and 7A-7B, to a first-stage, laid back orientation, as shown in FIGS. 3 and 8A-8B. As described above, the structure of the support brackets 30, 32 and wheel brackets 26, 28 of the hinge assembly 16 help provide stability to load support 14 as it is transitioned between the upright orientation and the first-stage, laid back orientation.

In the upright orientation, the toe plate 64 of the load support 14 is arranged generally parallel with the surface 18 underlying the wheel unit 12 and the load support 14, as shown in FIGS. 1-2 and 7A-7B. In the upright orientation, the respective channels of the support-bracket guide 46, 48 and the wheel-bracket guide 38, 40 are positioned substantially parallel to each other, and both brackets 26, 28, 30, 32 are raised off of the underlying surface 18, with the pins 72 and the load-assist axis 70 extending through an overlapping potion of the plates of the brackets 26, 28, 30, 32.

In the first-stage, laid back orientation, the toe plate 64 of the load support 14 is angled such that a front end 66 of the toe plate 64 is lifted away from the surface 18 while a rear end 68 of the toe plate 64 remains planted on the surface 18, as shown in FIGS. 3 and 8A-8B. Due to the relative motion of the support brackets 30, 32 with respect to the wheel brackets 26, 28, the tilted angle of the toe plate 64 causes the bottom edge 132, 134 of the support-bracket guides 46, 48 to rest on the underlying surface 18, also causing the load-assist axis 70 to move closer to the underlying surface 18 than in the upright orientation. The contact between the rear end 68 of the toe plate and the bottom edge 132, 134 of the support-bracket guides 46, 48 with the surface 18 provide support and stability as the load support 14 is tipped back from the upright position.

The support-bracket guides 46, 48 pivot relative to the wheel-bracket guides 38, 40 about the load-assist axis 70, compressing the spring 80, such that the support-bracket guides 46, 48 are positioned at an angle with respect to the wheel-bracket guide 38, 40. The support-bracket guides 46, 48 transition from resting on the first vertical edge 108, 110 of the wheel-bracket guides 38, 40 to resting on the second, angled edge 112, 114 of the wheel-bracket guides 38, 40. The second, angled edge 112, 114 of the wheel-bracket guides 38, 40 provides additional stability and support as the load support 14 is tipped backwards from the upright position.

The intermediate, first-stage, laid back orientation allows for an easier transition from the upright orientation to the second-stage, back orientation when lifting a load and pivoting the load support 14 relative to the wheel unit 12. The first-stage, laid back orientation enables a user to pivot the load support 14 and handle 60 relative to the wheel unit 12 while at least a portion of the toe plate 64 remains on the underlying surface 18. This allows for the load on the toe plate 64 to still be at least partially supported by the surface 18 and not entirely by the user as it is tilted back. The pivoted load support 14 and handle 60 in the first-stage, laid back orientation, move the center of gravity of the load closer to the wheel axle 50 and also create a longer lever arm so the load is easier to lift off the surface 18 and over the wheel axle 50 when transitioning to the second-stage, laid back orientation.

The wheel unit 12 allows the load transporter 10 to roll across the surface 18 and includes the axle 50 and a pair of wheels 52, 54 coupled to opposite ends of the axle 50 as shown in FIG. 1. The axle 50 extends through the apertures 74, 76 formed in each of the wheel-bracket mounts 34, 36 to couple the wheels 52, 54 to wheel brackets 26, 28 of the hinge assembly 16. The wheel unit 12 enables pivotable movement about a wheel axis defined by the axle 50. The axle 50 is spaced apart from the load-assist axis 70 and is used to transition the load transporter 10 from the first-stage, laid-back orientation to a second-stage, laid-back orientation, as shown in FIGS. 9A-9B.

In the second-stage, laid back orientation, the load support 14 and hinge assembly 16 are further tilted back and pivoted about the wheel axle 50 from the first-stage, laid back orientation to be raised off the surface 18 such that the entire toe plate 64, including the rear end 68, is lifted off the surface 18. The wheel brackets 26, 28 and the support brackets 30, 32 are generally in the same position relative to each other in the second-stage, laid back orientation as they are in the first-stage, laid back orientation.

The load support 14 is configured to be grasped and moved by the operator to change the position of the load transporter and includes a support frame 62, a handle 60, and the toe plate 64. The handle 60 is coupled to an upper end of the support frame 62, and the toe plate 64 is coupled to a lower end of the support frame 62. The toe plate 64 is coupled to each one of the support-bracket mounts 42, 44 to couple the load support 14 to the hinge assembly 16.

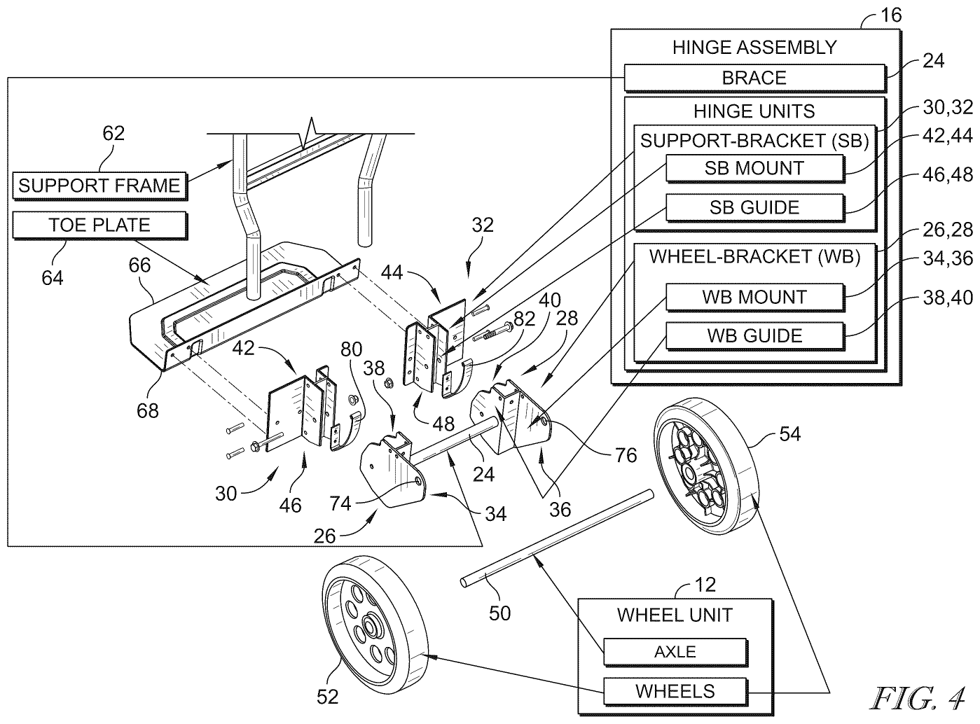

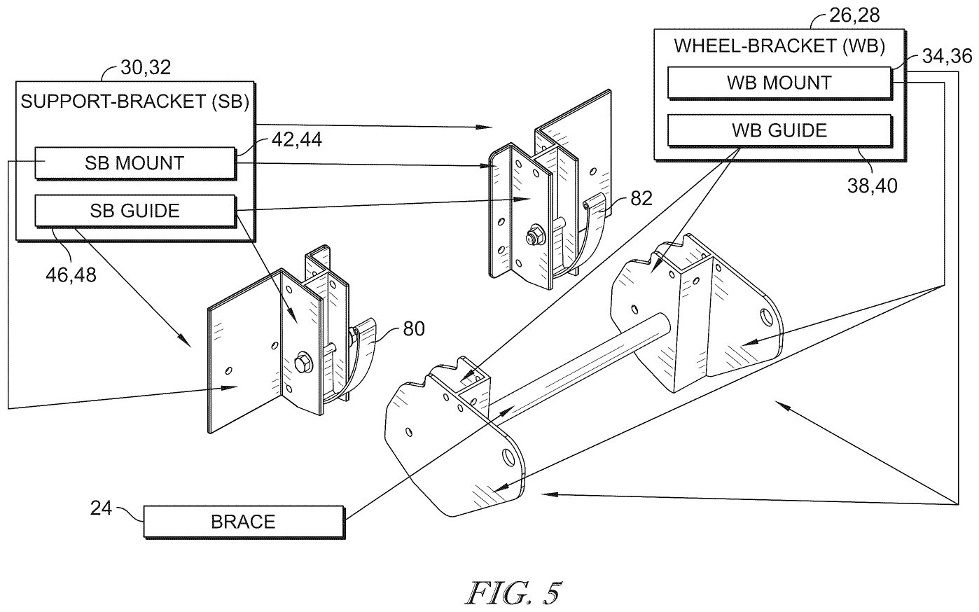

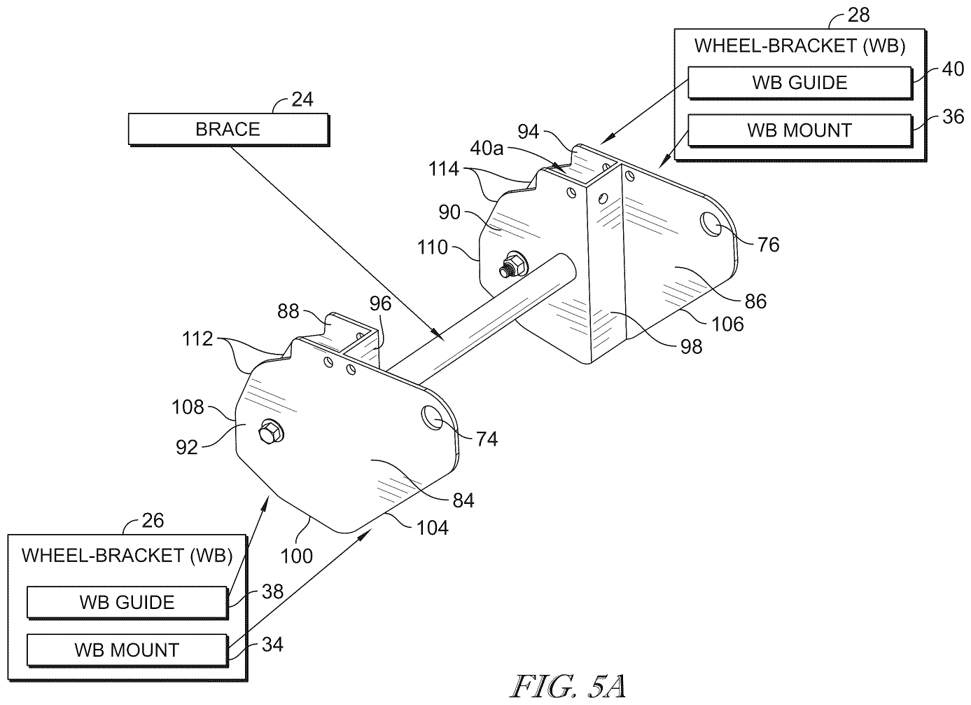

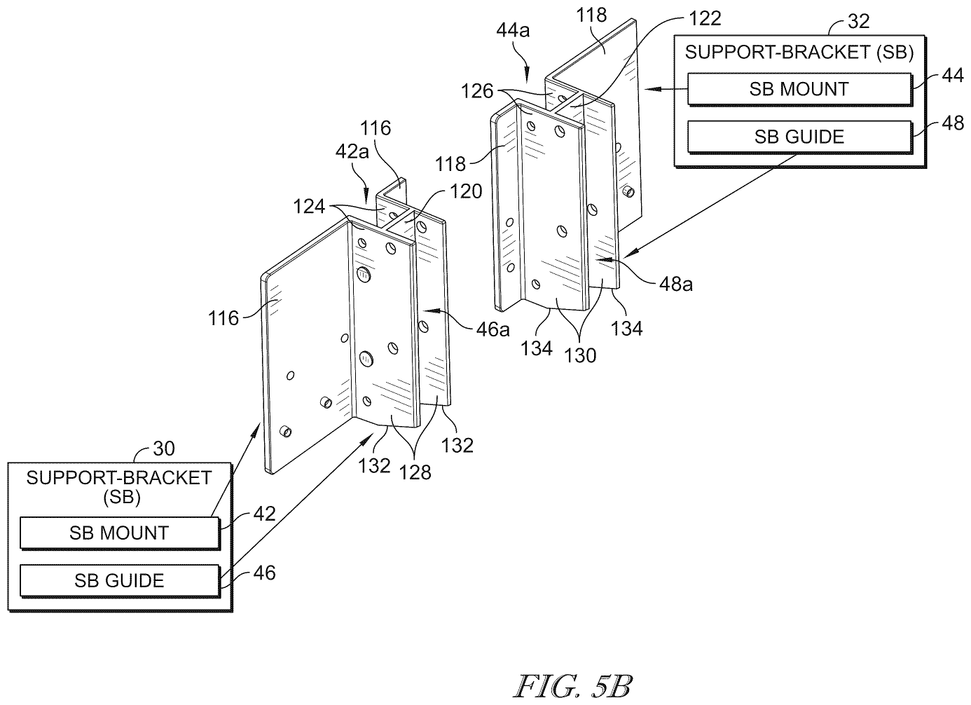

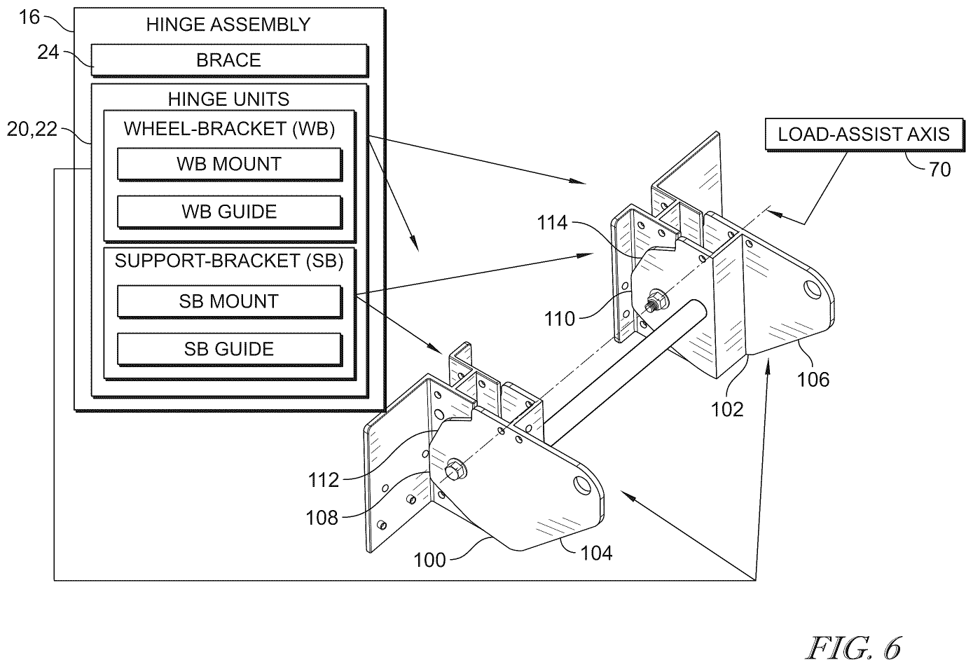

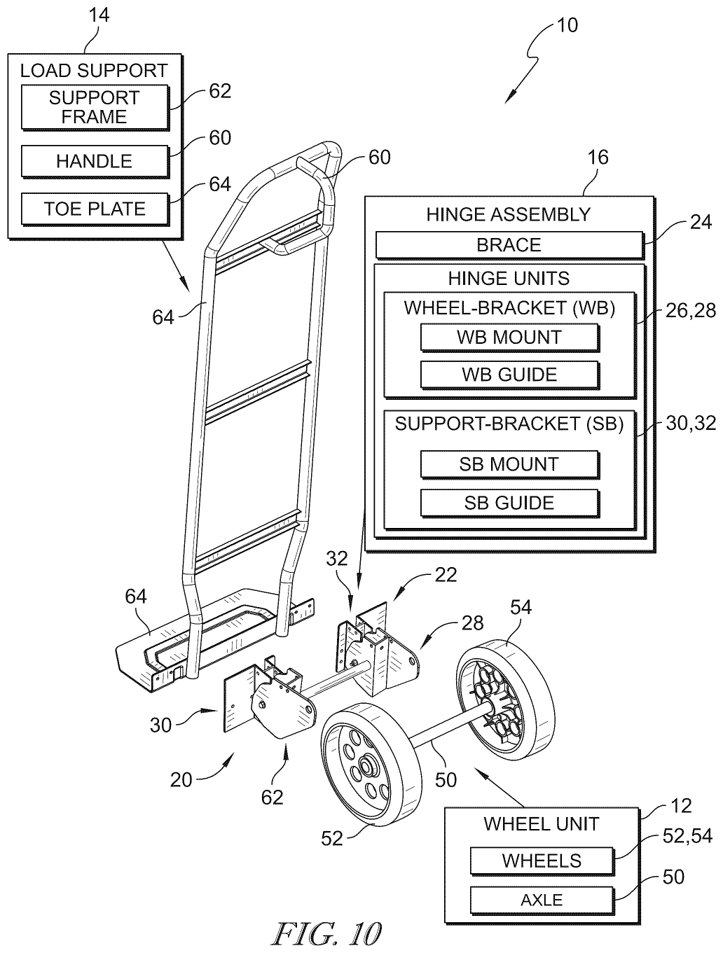

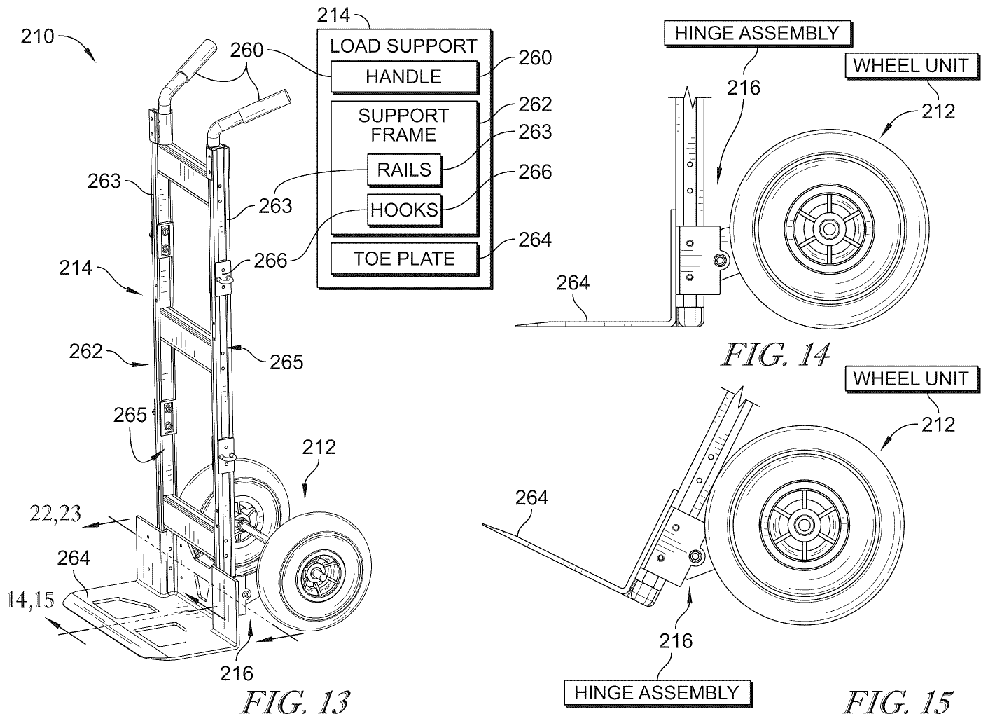

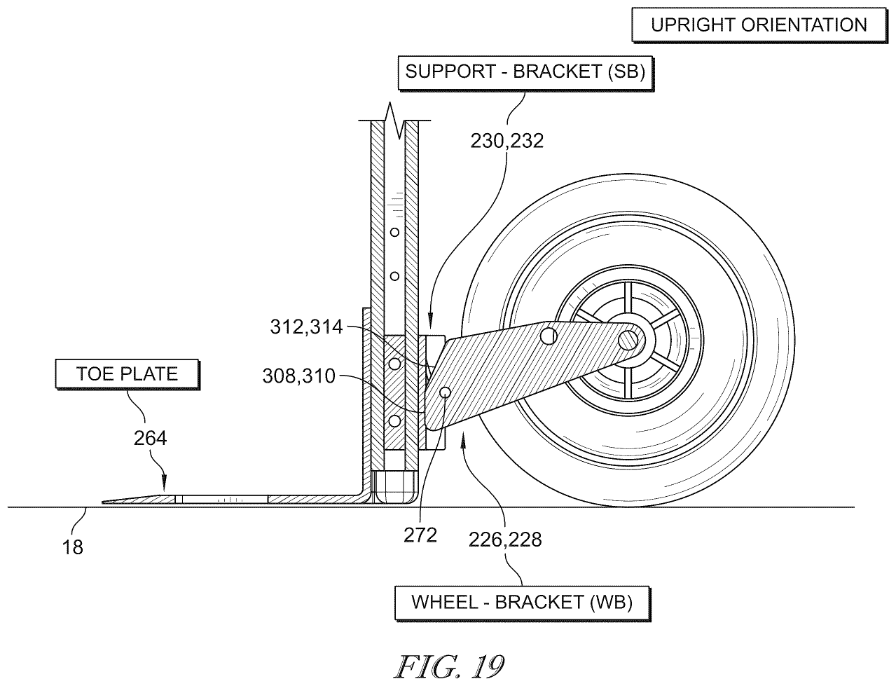

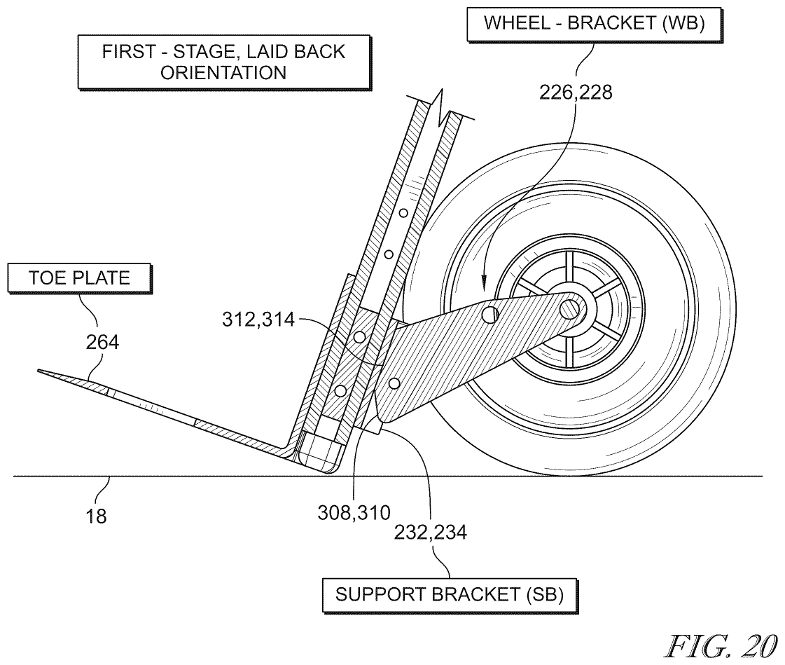

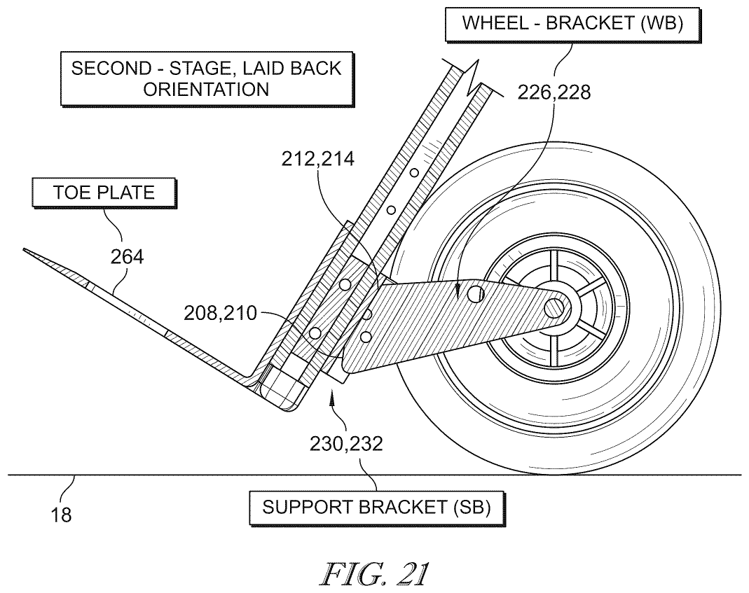

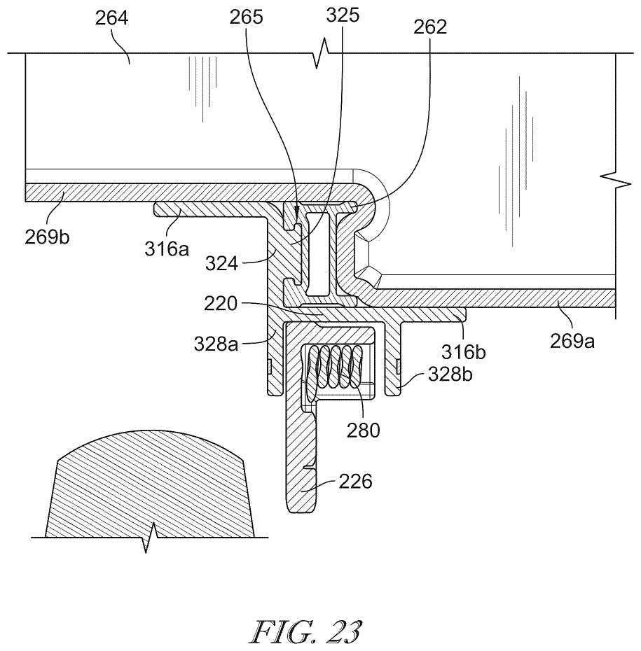

Another embodiment of a load transporter 210 in accordance with the present disclosure is shown in FIGS. 13-23. The load transporter 210 is similar to the load transporter 10 shown in FIGS. 1-12 and described herein. Accordingly, similar reference numbers in the 200 and 300 series indicate features that are common between the load transporter 10 and the load transporter 210. The description of the load transporter 10 is incorporated by reference to apply to the load transporter 210, except in instances when it conflicts with the specific description and the drawings of the load transporter 210. Similar to the load transporter 10 of FIGS. 1-12, the load transporter 210 includes a wheel unit 212 and a load support 214 rotatably coupled to the wheel unit 212. The load support 214 is configured to pivot relative to the wheel unit 212 to change between an upright orientation as shown in FIGS. 13-12 and 19, to a first-stage, laid back orientation as shown in FIGS. 15 and 20, and to a second-stage, laid back orientation as shown in FIG. 21.

In the illustrative embodiment show in FIGS. 13-23, the support frame 262 of the load support 214 includes two side rails 263 that extend from the toe plate 264 to the handle 260 of the load support 214. The side rails 263 are each shaped to form a corresponding channel 265 in an outer surface of the side rail 263. The channel 265 is shaped to receive components that have a connection feature corresponding to the shape of the channel such that the components may be slid into and along the channel 265. The channel 265 has a narrower width at the outer surface of the side rail 263 than at a base 267 of the channel 265. Coupled components may have a connection feature including a protrusion with a corresponding change in width so components slid within the channel are retained within the side rail 263. In the illustrative embodiment, a plurality of hooks 266 are one such component shaped to couple with the channel 265, as shown in FIG. 13. As will be described in more detail below, the support brackets 230, 232 are also configured to couple to the side rails 263 via the channel 265.

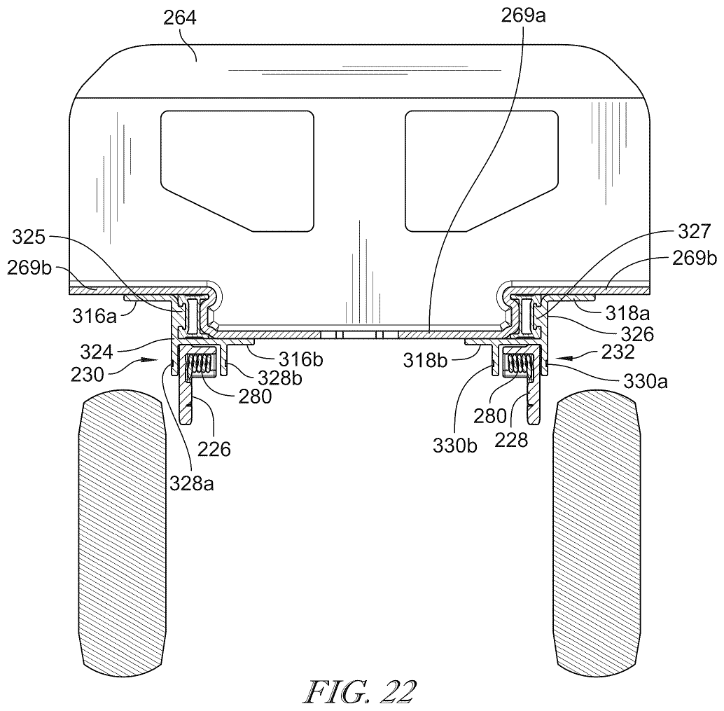

In the illustrative embodiment shown in FIG. 13-23, the toe plate 264 of the load support 214 is shaped to form a recess 261 along a back plate 269 of the toe plate 264. The back plate 269 is shaped such that a recessed portion 269a of the back plate 269 forming the recess 261 extends between the side rails 263 of the load support 214. The recessed portion of the back plate 269a may be offset from a non-recessed portion of the back plate 269b to accommodate the side rails 263. The offset in the back plate 269 corresponds to an offset of flanges 316, 318 of the support-bracket mount 242, 244 as shown in FIG. 22. When installed, the non-recessed portion of the back plate 269b sits flush with an outer one of the flanges 316, 318 and the recessed portion of the back plate 269a sits flush with an the inner one of the flanges 316, 318.

The hinge assembly 216 of the load transporter 210 includes a pair of hinge units 220, 222 and a brace 224 extending between and connecting the hinge units 220, 222. The hinge units 220, 222 are disposed on opposite ends of the brace 224 and couple the brace 224 to the wheel unit 212 and the load support 214. Each hinge unit 220, 222 includes a wheel bracket 226, 228 and a support bracket 230, 232 coupled to a respective wheel bracket 226, 228. Each wheel bracket 226, 228 couples the wheel unit 212 to the hinge assembly 216 via the axle 50. Each support bracket 230, 232 couples the load support 214 to the hinge assembly 216.

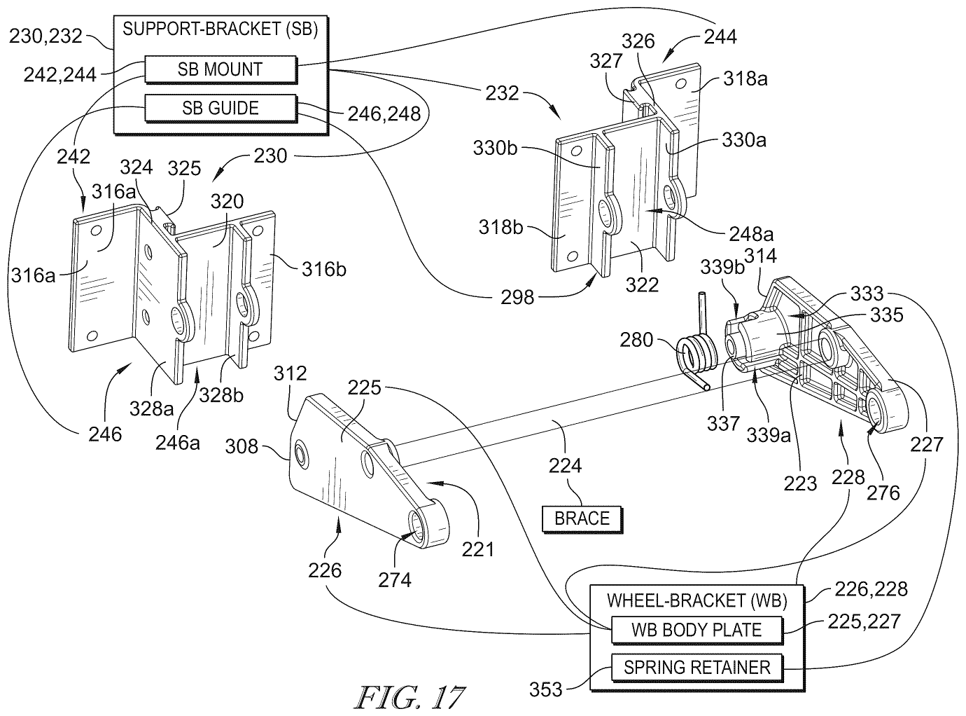

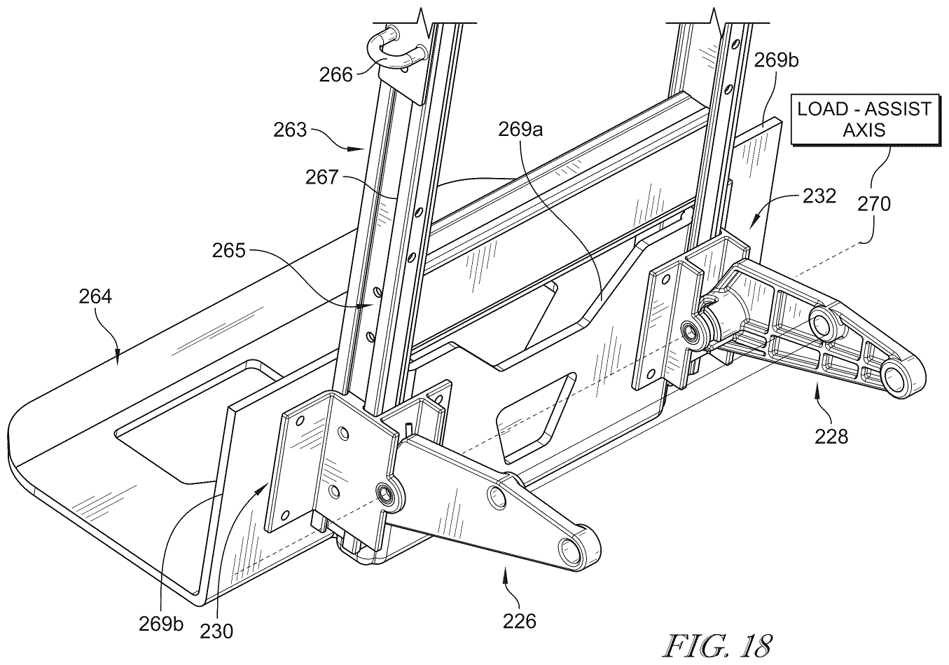

Each of the wheel brackets 226, 228 are made from one or more metallic materials as a one-piece, die cast component, such as an aluminum die cast component. This can facilitate and expedite manufacture of the wheel brackets 226, 228 and can facilitate service and/or replacement of the wheel brackets 226, 228 in the event they are damaged. Die cast manufacturing includes pouring molten metal into one or more molds. The die-cast wheel brackets 226, 228 include a body or back plate 225, 227 and a plurality of reinforcement ribs 221, 223 extending in a mold or part removal direction away from the body plate 225, 227 as shown in FIGS. 17 and 18. As such, each of the wheel brackets 226, 228 is formed without any overhangs in the mold or part removal direction to facilitate part removal from the mold and expedite manufacturing processes and efficiency.

The axle 50 extends between the wheel brackets 226, 228 parallel to the brace 224 that connects the two hinge units 220, 222. Each of the wheel brackets 226, 228 includes a plate that extends substantially perpendicular to the axle 250 and parallel to the wheels 252, 254 of the wheel unit 212. The wheel bracket 226, 228 is formed to include an aperture 274, 276 through which the axle 250 extends, coupling the hinge units 220, 222 to the wheel unit 212 so the wheel brackets 226, 228 can rotate about the axle 250. The brace 224 is connected to and extends between the wheel brackets 226, 228. The brace 224 extends substantially perpendicular to the wheel brackets 226, 228. Each of the wheel brackets 226, 228 cooperate with a respective support bracket 230, 232. As is described in more detail below, at least a portion of the wheel bracket 226, 228 is received by and fits within a respective support bracket 230, 232 to simply support the wheel brackets 234, 236 and to support transitioning the load support 14 between the different orientations.

The brace 224 is offset rearward from the load-assist axis 270 and forward of the axle 250. In other words, in the horizontal direction, the brace 224 is disposed between the load-assist axis 270 and the wheel unit 212. In the illustrative embodiment, a center point or central axis of the brace 24 is offset above the load-assist axis 270 and the axle 250. The brace 224 is positioned closer to the axle 250 than the load-assist axis 270 to cooperate with the axle 250 to provide a foot platform for a user to step on and apply pressure while lifting objects with the load transport 210.

The wheel brackets 226, 228 are angled on a bottom edge of the body plates 225, 227, as shown in FIGS. 17, 19, and 20. The angled shape of the wheel brackets 226, 228 provide support and assist the transition between the different orientations. A forward portion of each of the wheel brackets 226, 228, disposed near support-bracket mounts 242, 244 include a respective first edge 308, 110, and a respective second edge 312, 314. The first edge 308, 310 and second edge 312, 314 are angled with respect to each other. The first edge 308, 310 extends in a substantially vertical direction when the load support 214 is in the upright orientation, shown in FIGS. 13-14 and 19. The first, vertical edge 308, 310 abuts a portion of the support-bracket mount 242, 244 when the load support is in the upright orientation.

The second edge 312, 314 is angled with respect to the first edge 308, 310 and extends backwards and upwards from the first vertical edge 308, 310, towards an upper portion of the back plate of the wheel bracket 226, 228. The intersection of the first 308, 310 and second edges 312, 314 acts as a fulcrum or pivot point as the load support transitions between the upright orientation and the first-stage, laid back orientation. A portion of the support-bracket mounts 242, 244 rest against the second edge 312, 314 in the first-stage, laid back orientation as shown in FIGS. 15 and 20 and in the second-stage, laid back orientation as shown in FIG. 21. By supporting the support brackets 230, 232 and the attached toe plate 264, the edges 308, 310, 312, 314 of the wheel brackets 226, 228 act as a stop or guide to further support and stabilize the movement of the load support 14 during transition between the various orientations.

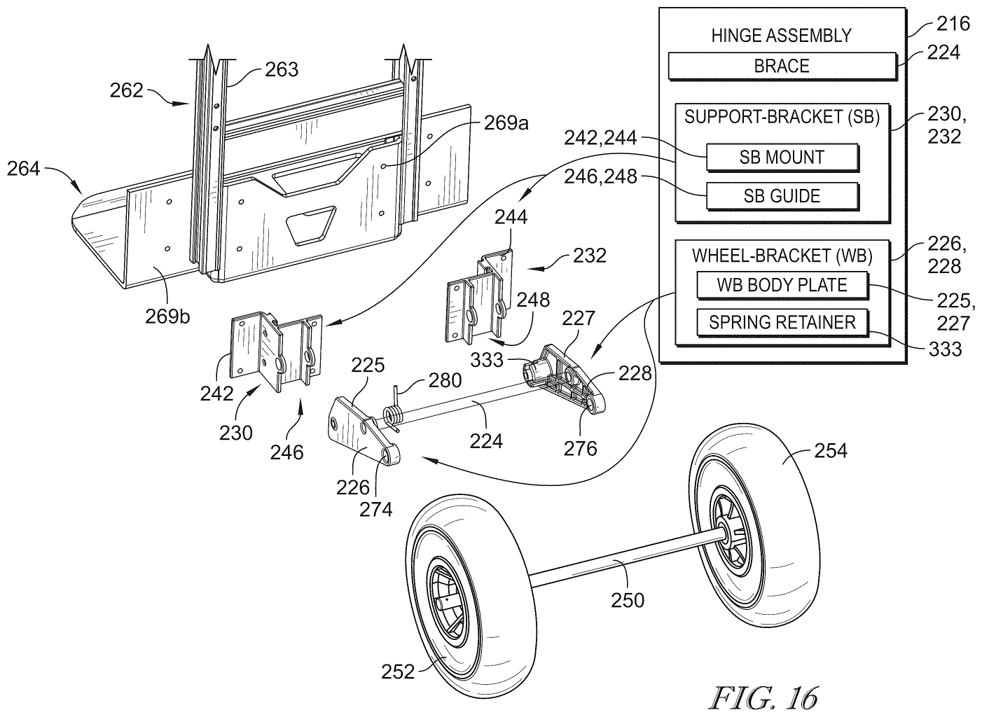

Each of the wheel brackets 226, 228 is shaped to form a spring retainer 333 integral with body plate 225, 227 and disposed on an inner facing surface of the wheel bracket 226, 228 near an end of the wheel brackets 226, 228 closest towards the support bracket 230, 232. The spring retainer 333 is cylindrical in shape and includes an outer wall 335 and an inner wall 337 disposed within the outer wall 335. The outer and inner walls 335, 337 are both cylindrical and concentric with one another such that a coil spring 280 can be placed around the inner wall 337, between the outer and inner walls 335, 337. The outer wall 335 is shaped to form two slots 339a, 339b thorough which the ends of the coil spring 280 extend. The slots 339a, 339b hold the spring 280 in place relative to the wheel bracket 226, 228 such that the spring compresses and exerts a force on the support brackets 230, 232 when the support brackets 230, 232 and the wheel brackets 226, 228 pivot relative to one another and transition from the upright orientation to the first-stage, laid back orientation. In some embodiments, as shown in FIGS. 16-17 and 22-23, the spring 280 may be a coil or torsion spring disposed around the hinge point of the hinge assembly.

Turning to the support brackets 230, 232 of the hinge assembly 216, each support bracket 230, 232 includes a support-bracket mount 242, 244 and a support-bracket guide 246, 248. At least a portion of the support-bracket mounts 242, 244 extends substantially perpendicular to at least a portion of the support-bracket guides 246, 248 and couples to the load support 214. Each support-bracket mount 242, 244 includes a pair of flanges 316, 318 having an outer flange 316a, 318a and an inner flange 316b, 318b. A plate 324, 326 extends between and connects the inner flange 316b, 318b and the outer flange 316a, 318a in a respective pair of flanges. The flanges 316, 318 extend parallel to each other and the inner flange 316b, 318b and the outer flange 316a, 318a are offset from each other. The plate 324, 326 is perpendicular to the flanges 316, 318 and extends between the inner flange 316b, 318b and the outer flange 316a, 318a, connecting the inner flange 316b, 318b and the outer flange 316a, 318a 318.

The plate 324, 326 includes a connector formation 325, 327 on an inward facing surface of the plate 324, 326, facing towards the inner flange 316b, 318b. The connection formation 325, 327 includes a protrusion shaped to correspond to a shape of the channel 265 formed in the side rail 263 such that the support-bracket mount 242, 244 can slide onto the rail side 263 with the connector formation 325, 327 fitting inside and sliding along the channel 265. When the support-bracket mount 242, 244 is coupled to the support frame 262, as shown in FIGS. 16, 22, and 23, the connector formation 325, 327 sits within the channel 265, and the flanges 316, 318 are attached to and sit flush against the toe plate 264 of the load support 214. The toe plate 264 extends between the two support-bracket mounts 242, 244 of the hinge assembly 216 and couples the support-bracket mounts 242, 244 to the load support 214.

At an opposite end of each of the support brackets 230, 232 from the support-bracket mount 242, 244 is a respective support-bracket guide 246, 248. Each of the support-bracket guides 246, 248 defines a respective support-guide channel 246a, 248a formed by a pair of parallel plates 328, 330 including an outer plate 328a, 330a and an inner plate 328b, 330b. The plates 328, 326 extend perpendicular to the toe plate 264 and the flanges 316, 318 of the support-bracket mounts 242, 244.

An outer plate 328a, 330a of the pair of parallel plates extends from and is co-linear with the plate 324, 326 of the respective support-bracket mount 242, 244. The support-bracket guides 246, 248 include a plate 320, 322 that extends between the parallel plates 328, 330. The flange 316 is disposed at an end of the plate 320, 322. The connector formation 325, 327 is disposed on an inner side of the plate 324, 326 that faces towards the plate 320, 330. Each support-guide channel 246a, 248a cooperates with and receives a respective wheel bracket 226, 228. When assembled, an end of the wheel bracket 226, 228 including the spring retainer 333 fits within the support bracket 230, 232, between the parallel plates 328, 330 of each of the support-bracket guides 46.

The respective parallel plates 328, 330 of the support-guide channel 246a, 248a and the inner wall 337 of the spring retainer 333 of the wheel bracket 226, 228 form apertures that align when assembled to allow for a pin 272 to extend through each respective hinge unit 220, 222 to couple the support-bracket guide 246, 248 to a respective wheel bracket 226, 228. The pin 272 provides pivotable movement between the support brackets 230, 232 and the wheel brackets 226, 228 about a load-assist axis 270, with the pins 272 defining the load-assist axis 270.

1. A load transporter comprising
a wheel unit including a first wheel, a second wheel, and an axle extending between and interconnecting the first wheel and the second wheel,
a load support including a support frame, a handle coupled to an upper end of the support frame, and a toe plate coupled to a lower end of the support frame, and
a hinge assembly including a left hinge unit, a right hinge unit, and a brace extending between and connecting the left hinge unit and the right hinge unit, the left hinge unit and the right hinge unit each including a wheel bracket and a support bracket coupled to the wheel bracket, each wheel bracket coupled to the axle of the wheel unit and the brace, each support bracket including a support-bracket mount coupled to the toe plate of the load support and a support-bracket guide coupled to a respective wheel bracket,
wherein each wheel bracket is coupled to a respective support bracket for pivotable movement relative to the load support about a load-assist axis from an upright orientation, in which the toe plate is arranged generally parallel with a surface underlying the wheel unit and the load support, to a first-stage, laid back orientation, in which a front end of the toe plate is lifted away from the surface while a rear end of the toe plate remains planted on the surface, and for pivotable movement about a wheel axis defined by the axle and spaced apart from the load-assist axis from the first-stage, laid-back orientation to a second-stage, laid-back orientation in which the front end and the rear end of the toe plate are lifted away from the surface,
and wherein each wheel bracket is fixed relative to the axle and the brace extends between and connects the wheel bracket of each respective hinge unit to unify the wheel brackets, the brace, the axle, and the first and second wheels for motion as a unit during transition between the upright orientation, the first-stage, laid-back orientation, and the second-stage, laid-back orientation so that instability of the load transporter potentially caused by unsynchronized movement of the left and right hinge units is avoided.

2. The load transporter of claim 1, wherein the support-bracket guide includes two parallel flanges at least partially defining a first channel.

3. The load transporter of claim 2, wherein each wheel bracket includes a wheel-bracket mount coupled to the axle of the wheel unit and a wheel-bracket guide at least partially defining a second channel, each support-bracket guide disposed at least partially within the second channel of a respective wheel-bracket guide.

4. The load transporter of claim 3, wherein, the first channel of the support-bracket guide is disposed at least partially within the second channel of the wheel-bracket guide.

5. The load transporter of claim 3, wherein a biasing means is disposed within the first channel at least partially defined by the support-bracket guide and biases the support-bracket guide and the wheel-bracket guide towards the upright orientation.

6. The load transporter of claim 2, wherein the support-bracket mount is perpendicular to the two parallel flanges of the support-bracket guide.

7. The load transporter of claim 2, wherein the support-bracket guide is an I-beam shape.

8. The load transporter of claim 2, wherein the wheel bracket includes a body plate coupled to the support-bracket guide and a plurality of reinforcement ribs extending away from an inward-facing surface of the body plate.

9. The load transporter of claim 8, wherein the wheel bracket further includes a spring retainer having an outer wall and an inner wall, and wherein a spring is disposed between the outer wall and the inner wall to bias the support-bracket guide and the wheel bracket towards the upright orientation.

10. The load transporter of claim 2, wherein the body plate of the wheel bracket is at least partially disposed between and supported by the two parallel flanges of the support-bracket guide within each respective hinge unit.

11. The load transporter of claim 1, wherein the wheel bracket is shaped to include a first edge that abuts the support-bracket mount in the upright orientation and a second edge that abuts the support-bracket mount in the first-stage, laid back orientation and the second-stage, laid back orientation.

12. The load transporter of claim 11, wherein, in the upright orientation, the first edge is in contact with the support-bracket guide to block movement of the load support about the load-assist axis in a first direction about the load-assist axis and the second edge is spaced apart from the support-bracket guide.

13. The load transporter of claim 12, wherein, in the first-stage, laid back orientation or the second-stage, laid back orientation, the second edge is in contact with the support-bracket guide to block movement of the load transporter about the load-assist axis in a second direction about the load-assist axis opposite the first direction and the first edge is spaced apart from the support-bracket guide.

14. The load transporter of claim 1, further including a biasing mechanism disposed between the support-bracket guide and the wheel bracket of each respective hinge unit to bias the hinge assembly towards the upright orientation.

15. The load transporter of claim 1, wherein the toe plate includes a vertical flange and a horizontal flange disposed at a 90 degree angle to the vertical flange, the vertical flange attached to the support-bracket mount via fasteners on either side of the support frame.

16. The load transporter of claim 1, wherein the axle extends through an axle aperture in the wheel bracket to couple the wheel unit to the hinge assembly and the brace extends parallel to the axle and is located between the axle and the load assist axis.

17. The load transporter of claim 1, wherein a hinge fastener extends though concentric apertures in the wheel bracket and the support-bracket guide to couple the support-bracket guide to the wheel bracket of each respective hinge unit.

18. The load transporter of claim 1, wherein the support-bracket guide and the wheel bracket of each respective hinge unit include coaxial apertures, the left hinge unit and the right hinge unit each including a respective hinge axle extending through the coaxial apertures to couple the support-bracket guide to the wheel bracket.

19. The load transporter of claim 1, wherein the support frame includes at least one side rail extending between the handle and the toe plate, the at least one side rail shaped to define a channel.

20. The load transporter of claim 19, wherein the support-bracket mount includes a protrusion shaped to correspond to a shape of the channel, the protrusion positioned at least partially within the channel of the at least one side rail to couple the support-bracket mount coupled to the support frame.
